(19) United States
(12) Patent Application Publication
(10) Pub. No.: US 2016/0301233 A1
(43) Pub. Date: Oct. 13, 2016

(54) POWER SUPPLY DEVICE AND METHOD FOR CONTROLLING POWER SUPPLY DEVICE

(71) Applicants: Toshiyuki Takeuchi, Nagano (JP); Yusaku Ido, Gifu (JP); Takashi Yamada, Gifu (JP)

(72) Inventors: Toshiyuki Takeuchi, Nagano (JP); Yusaku Ido, Gifu (JP); Takashi Yamada, Gifu (JP)

(73) Assignee: OMRON AUTOMOTIVE ELECTRONICS CO., LTD., Aichi (JP)

(21) Appl. No.: 15/093,963

(22) Filed: Apr. 8, 2016

(30) Foreign Application Priority Data
Apr. 10, 2015 (JP) 2015-081208

(51) Int. Cl. H02J 7/00

(52) U.S. Cl. CPC H02J 7/0068

(57) ABSTRACT

A power supply device includes: a DC power supply circuit which supplies DC power to a first battery; a smoothing capacitor connected to an output side of the DC power supply circuit; a voltage conversion circuit; a control unit which controls the voltage conversion circuit; an input voltage detection unit which detects an input voltage of the voltage conversion circuit; a switch which electrically connects or disconnects the first battery to the power supply device; and a control stopping unit which stops voltage conversion control, in a case where the input voltage is less than a first voltage reference value. In a case where the switch is switched off, after the voltage conversion control is continued for a predetermined time such that electric charges charged in the smoothing capacitor are discharged by a predetermined amount, the control stopping unit stops the voltage conversion control.

### CROSS-REFERENCES TO RELATED APPLICATIONS

This application is based upon and claims the benefit of priority from Japanese Patent Application No. 2015-081208, filed on Apr. 10, 2015; the entire contents of which are incorporated herein by reference.

### FIELD

One or more embodiments of the present invention relate to a power supply device including a DC power supply and a DC-DC converter that converts a voltage of a high voltage battery which is charged by the DC power supply into a low voltage, and a method for controlling the power supply device.

### BACKGROUND

Generally, in a power supply device or the like which includes a DC power supply for a vehicle, a voltage conversion circuit such as a DC-DC converter that drops a voltage of a high voltage battery which is charged by the DC power supply, and a capacitor for smoothing a voltage, a mechanism which discharges electric charges remaining in the capacitor is widely known.

For example, JP-A-10-224902 discloses a motor drive control device of an electric vehicle which aims to quickly discharge a DC link capacitor after a key switch is switched off. After the key switch is switched off, the motor drive control device starts operations of load switches which switch on or off the entire load of a battery, starts up an auxiliary circuit, and discharges electric charges which are charged in the DC link capacitor using the auxiliary circuit. Accordingly, electric charges remaining in the DC link capacitor can be quickly discharged after the key switch is switched off, without a discharging resistor, and thus, it is possible to prevent power of a main battery from being wastefully consumed, and to quickly perform maintenance (for others, refer to JP-A-03-222602 having the same technology).

In addition, International Publication No. WO 2012/049755 discloses a power supply device for a vehicle which is configured such that a charger receives power from an external power supply and charges a main storage device and an auxiliary storage device, and includes a capacitor for smoothing the charged power that is output to the main storage device. The power supply device for a vehicle controls charging of the auxiliary storage device which is charged by the charger such that the auxiliary storage device can receive remaining electric charges of the capacitor, and controls the charger such that the remaining electric charges of the capacitor are discharged to the auxiliary storage device after the charging of the main storage device which is performed by the charger is terminated.

JP-A-2005-304128 discloses a power supply protection device which aims to solve a problem in which a protection operation cannot be performed because a current is not detected at the time of a thermal breakdown of a main switching element due to continuous flowing of a relatively high current. The power supply protection device is configured by an overload sensing unit which detects a current flowing through a main switching element, a low input sensing unit which detects that a primary DC input voltage is equal to or less than a predetermined value, and an overload protection circuit which stops switching of the main switching element when a current flowing through the main switching element is equal to or greater than a predetermined value and a primary DC input is equal to or less than the predetermined value.

In addition, JP-A-2004-336908 discloses a switching power supply of a synchronous rectification type which aims to reliably avoid a reverse current or a regenerative current before the current is generated. At the time of normal operation, the switching power supply supplies a control signal which is generated based on an output voltage to a switch circuit for excitation which excites primary winding wires of a transformer and a switch circuit for rectification which rectifies an output of the transformer. If an input voltage which is monitored by a monitor circuit is equal to or less than a predetermined value, the control signal to be supplied to the switch circuit for rectification is blocked, and the switch circuit for rectification stops.

### SUMMARY

One or more embodiments of the invention provide a power supply device which quickly discharges electric charges remaining in a smoothing capacitor in a case where a battery is removed after a charging operation is terminated or travel of a vehicle is terminated, and a method for controlling the power supply device.

In order to solve the aforementioned problem, a power supply device which charges a battery and converts a DC voltage into another DC voltage, includes a DC power supply circuit which supplies DC power to a first battery; a smoothing capacitor which is connected to an output side of the DC power supply circuit; a voltage conversion circuit which converts a voltage output from the DC power supply circuit into another voltage, and which supplies DC power to a second battery; a control unit which controls a voltage conversion of the voltage conversion circuit; an input voltage detection unit which detects an input voltage of the voltage conversion circuit; a switch which electrically connects or disconnects the first battery to the power supply device; and a control stopping unit which stops voltage conversion control performed by the control unit, in a case where the input voltage detected by the input voltage detection unit is less than a first voltage reference value. In a case where the switch is switched off, after the voltage conversion control performed by the control unit is continued for a predetermined time such that electric charges charged in the smoothing capacitor are discharged by a predetermined amount, the control stopping unit stops the voltage conversion control performed by the control unit.

According to this, it is possible to provide a power supply device in which, although the voltage that is input to the voltage conversion circuit is less than the reference value by which the voltage conversion control is stopped, in a case where the battery is in a state of being disconnected, the voltage conversion is performed for a predetermined time such that the electric charges which are charged in the smoothing capacitor are discharged by a predetermined amount, and thus, in a case where the battery is removed after the charging operation is terminated or the travel of a vehicle is terminated, the electric charges remaining in the smoothing capacitor can be quickly discharged.

Furthermore, when an input voltage detected by the input voltage detection unit is less than a second voltage reference value that is smaller than the first voltage reference value, the control stopping unit may stop the voltage conversion control perforated by the control unit.

According to this, by performing the voltage conversion control until a voltage which is input to a voltage conversion circuit is less than a predetermined voltage reference value, electric charges remaining in a smoothing capacitor can become very stable.

In order to solve the aforementioned problem, a method for controlling a power supply device which includes a DC power supply circuit which supplies DC power to a first battery, a smoothing capacitor which is connected to an output side of the DC power supply circuit, a voltage conversion circuit which converts a voltage output from the DC power supply circuit and which supplies DC power to another battery, includes a stopping voltage conversion control, in a case where a voltage input to the voltage conversion circuit is less than a predetermined reference value; and causing the voltage conversion circuit to stop after a voltage conversion is continued for a predetermined time such that electric charges charged in the smoothing capacitor are discharged by a predetermined amount, in a case where the first battery is in a state of being disconnected.

According to this, it is possible to provide a method for controlling the power supply device in which, although the voltage that is input to the voltage conversion circuit is less than the reference value by which the voltage conversion control is stopped, in a case where the battery is in a state of being disconnected, the voltage conversion is performed for a predetermined time such that the electric charges which are charged in the smoothing capacitor are discharged by a predetermined amount, and thus, in a case where the battery is removed after the charging operation is terminated or the travel of a vehicle is terminated, the electric charges remaining in the smoothing capacitor can be quickly discharged.

As described above, according to one or more embodiments of the invention, it is possible to provide a power supply device and a method for controlling the power supply device in which, in a case where a battery is removed after a charging operation is terminated or travel of a vehicle is terminated, electric charges remaining in a smoothing capacitor can be quickly discharged.

### BRIEF DESCRIPTION OF THE DRAWINGS

FIG. 1 is a block diagram illustrating a power supply device according to an embodiment of the invention;

FIG. 2 is a flowchart illustrating a method for controlling the power supply device according to the embodiment of the invention;

FIG. 3 is an explanatory block diagram illustrating an operation at the time of charging, in the power supply device according to the embodiment of the invention;

FIG. 4 is an explanatory block diagram illustrating an operation at the time of terminating charging, in the power supply device according to the embodiment of the invention;

FIG. 5 is an explanatory block diagram illustrating an operation at the time of disconnecting a high voltage battery, in the power supply device according to the embodiment of the invention;

FIG. 6 is an explanatory block diagram illustrating the time when discharging is terminated, in the power supply device according to the embodiment of the invention; and

FIG. 7A is a characteristic diagram illustrating voltage characteristics at the time of disconnecting a switch, in the power supply device according to the embodiment of the invention, and FIG. 7B is a characteristic diagram illustrating voltage characteristics at the time of connecting a switch, in the power supply device according to the embodiment of the invention.

### DETAILED DESCRIPTION

In embodiments of the invention, numerous specific details are set forth in order to provide a thorough understanding of the invention. However, it will be apparent to one of ordinary skill in the art that the invention may be practiced without these specific details. In other instances, well-known features have not been described in detail to avoid obscuring the invention.

Hereinafter, one or more embodiments of the inventions will be described with reference to the accompanying drawings.

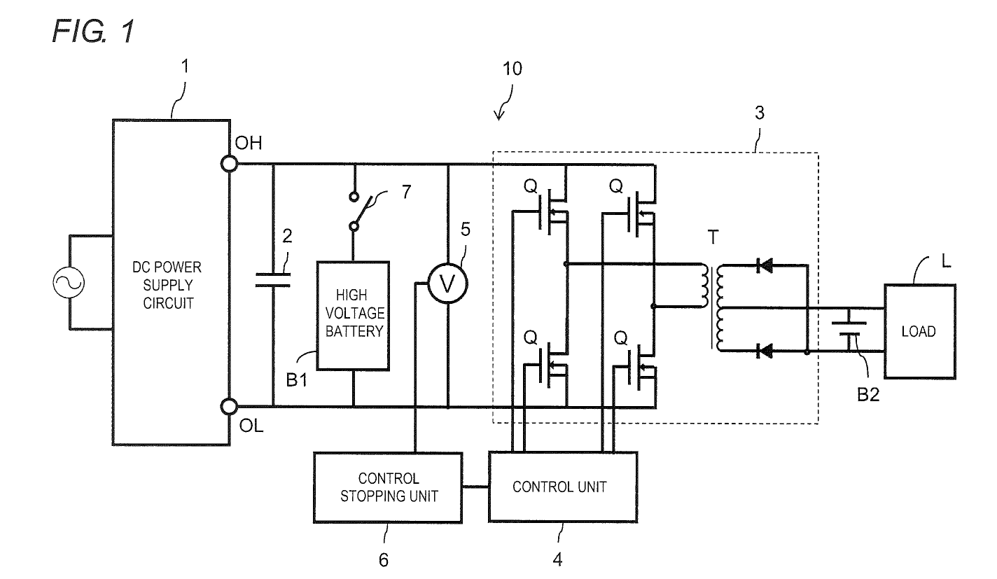

Referring to FIG. 1, a power supply device 10 according to the present embodiment will be described. A power supply device according to one or more embodiments of the inventions is a DC power supply device which converts an AC voltage from a commercial AC power supply device into a DC voltage, or a DC power supply device based on power which is obtained from a power generator that uses driving force or the like of a vehicle as a power source. In addition, the power supply device has a charging function to a battery (secondary battery), and has a DC-DC conversion function in which a voltage of the DC power supply device is boosted or dropped to another voltage.

The power supply device 10 according to the present embodiment includes a DC power supply circuit 1 which performs an AC-DC conversion with respect to a voltage from a commercial AC power supply device. The DC power supply circuit 1 supplies a high DC voltage (for example, 300 V) that is converted from the commercial AC power supply device to a high voltage battery B1 (first battery). The AC-DC conversion of the DC power supply circuit 1 is performed by using a known method.

The power supply device 10 further includes a smoothing capacitor 2 which is connected to an output side of the DC power supply circuit 1, more specifically, the smoothing capacitor 2 having one terminal connected to a positive electrode OH of the DC power supply circuit 1 and the other terminal connected to a negative electrode OL of the DC power supply circuit 1. The smoothing capacitor 2 smooths a voltage which is supplied to a high voltage battery B1, but the smoothing capacitor 2 is also charged at the time of terminating charging or the like, and thus, the smoothing capacitor 2 has remaining electric charges. At this time, if the high voltage battery B1 is removed, an operator can receive an electric shock by the remaining electric charges of the smoothing capacitor 2. Accordingly, it is necessary to quickly discharge the remaining electric charge of the smoothing capacitor 2 after terminating the charging or the like.

Furthermore, the power supply device 10 converts a voltage which is output from the DC power supply circuit 1 into another voltage, supplies a DC power supply voltage to a battery B2 (second battery) different from the high voltage battery B1, and includes a voltage conversion circuit 3 which performs a so-called DC-DC conversion. In the present embodiment, the battery B2 is, for example, 12 V, and the voltage conversion circuit 3 performs a voltage conversion, for example, from 300 V to 12 V. The voltage conversion circuit 3 includes a bridge circuit which includes four field effect transistors Q, one terminal connected to the positive electrode OH of the DC power supply circuit 1, and the other terminal connected to the negative electrode OL of the DC power supply circuit 1, and a transformer unit T. A DC-DC conversion of the voltage conversion circuit 3 is performed by using a known method. The battery B2 supplies power to a load L such as an electronic apparatus which is employed in a vehicle or the like.

The power supply device 10 further includes a control unit 4 which controls the voltage conversion of the voltage conversion circuit 3. The control unit 4 is configured by a microcontroller or the like, appropriately controls the bridge circuit, and performs a voltage conversion of a voltage which is output from the DC power supply circuit 1 so as to be suitable for a voltage of the battery B2.

The power supply device 10 further includes an input voltage detection unit 5 which includes one terminal connected to the positive electrode OH of the DC power supply circuit 1 and the other terminal connected to the negative electrode OL of the DC power supply circuit 1, and detects an input voltage of the voltage conversion circuit 3. The input voltage detection unit 5 is a voltage sensor which detects an output voltage of the DC power supply circuit 1 and an input voltage of the voltage conversion circuit 3.

The power supply device 10 further includes a switch 7 which electrically connects or disconnects the high voltage battery B1 to the power supply device 10. When the switch 7 is in an ON state, the one terminal of the high voltage battery B1 is connected to the positive electrode OH of the DC power supply circuit 1 and the other terminal of the high voltage battery B1 is connected to the negative electrode OL of the DC power supply circuit 1. However, when the switch 7 is in an OFF state, the high voltage battery B1 is disconnected from the circuit of the power supply device 10. In a case where the high voltage battery B1 is intended to be removed, the switch 7 electrically disconnects the high voltage battery B1 from the power supply device 10. The power supply device 10 may include a switch state sensing unit (not illustrated) which senses an ON or OFF state of the switch 7. In addition, instead of the switch 7, a power supply stop sensing unit which senses that supplying of the power from the high voltage battery B1 is stopped may be provided, and when the power supply stop sensing unit senses that supplying of the power from the high voltage battery B1 is stopped, it is regarded that the high voltage battery B1 is disconnected from the power supply device 10.

The power supply device 10 further includes a control stopping unit 6 which stops voltage conversion control which is performed by the control unit 4. The control stopping unit 6 is connected to the input voltage detection unit 5 and the control unit 4, and controls the voltage conversion control of the control unit 4, based on an input voltage which is input to the voltage conversion circuit 3 and is detected by the input voltage detection unit 5. In a case where the high voltage battery B1 is connected to the power supply device 10, the control stopping unit 6 makes the control unit 4 perform voltage conversion control until the converted voltage becomes a predetermined input voltage (first voltage reference value) such that the power is supplied to the battery B2 and the load L, and stops the voltage conversion control after the voltage becomes a voltage lower than a predetermined input voltage, as will be described below. In addition, in a case where the high voltage battery B1 is disconnected from the power supply device 10, regardless of the load L, the control stopping unit 6 makes the control unit 4 perform the voltage conversion control during a predetermined time or until the converted voltage becomes a predetermined input voltage (second voltage reference value) so as to start the discharge, and stops the discharge by stopping the voltage conversion control after a predetermined time passes or the voltage becomes a voltage lower than the predetermined input voltage (second voltage reference value).

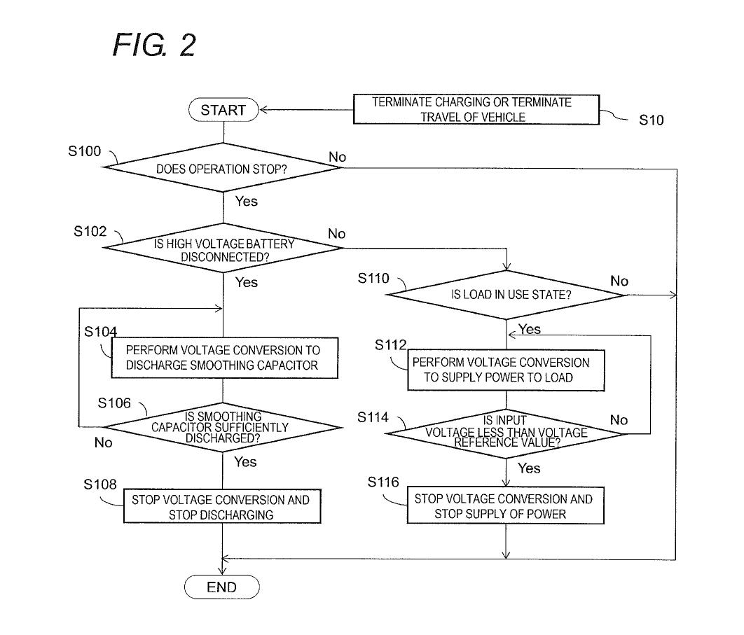

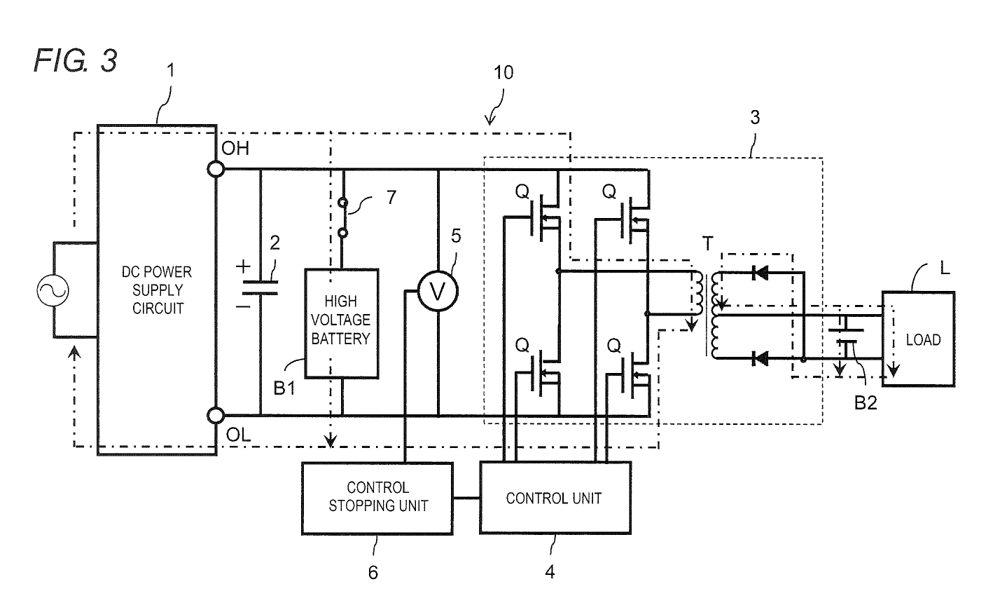

A method for controlling the power supply device 10 will be described with reference to FIGS. 2 to 6. S of the flowchart means step. FIG. 3 illustrates a case where the power supply device 10 performs charging from a commercial AC power supply device or by travel of a vehicle. In this case, in the power supply device 10, the DC power supply circuit 1 performs an AC-DC conversion and charges the high voltage battery B1 to, for example, 300 V, and the control unit 4 controls the voltage conversion circuit 3 to perform a DC-DC conversion to, for example, 12 V and the voltage is supplied to the battery B2 and the load L. In this case, the smoothing capacitor 2 is also charged with electric charges.

The flowchart of FIG. 2 illustrates steps after the time when charging is terminated as illustrated in FIG. 3. That is, the flowchart starts after charging of the power supply device 10 from the commercial AC power supply device or charging of the power supply device 10 which is performed by travel of a vehicle is terminated in S10. In S100, the power supply device 10 checks whether or not an operation of equipment, a vehicle, or the like which uses the power supply device 10 is completely stopped. In a case where the operation is not completely stopped, the power supply device 10 performs nothing in particular.

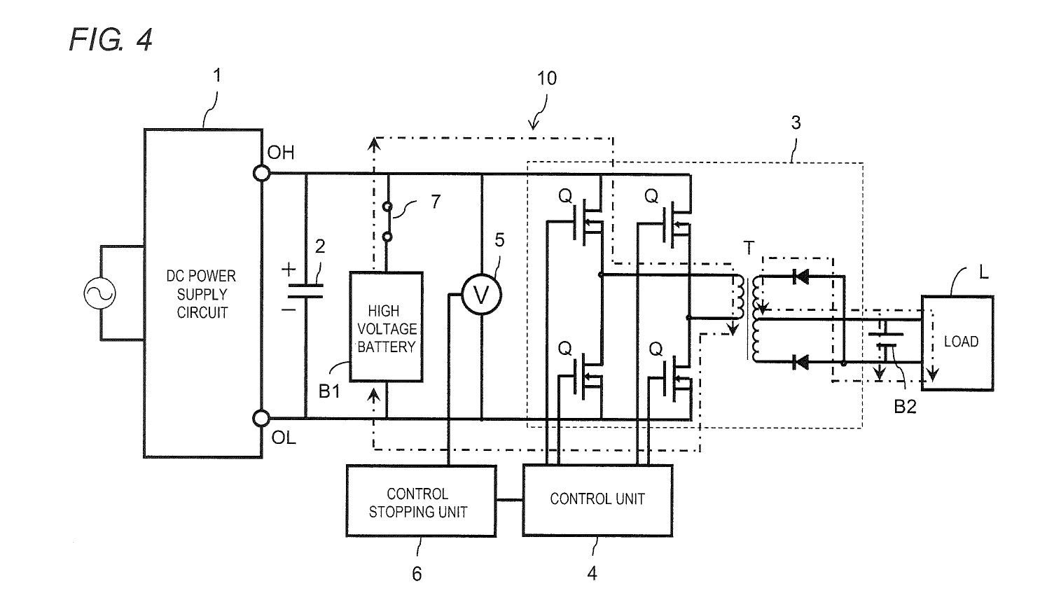

In S102, the power supply device 10 checks whether or not the switch 7 disconnects the high voltage battery B1. In a case where the high voltage battery B1 is in a state of being connected, the power supply device 10 confirms whether or not the load L connected to the battery B2 is in a state of being used in S110. If the load L is not in a state of being used, the power supply device 10 performs nothing in particular, but in a case where the load L is in a state of being used, the power supply device 10 makes the control unit 4 perform the voltage conversion control in S112, and thereby the battery B2 is charged and power is supplied to the load L. That is, as illustrated in FIG. 4, the power supply device 10 performs a voltage conversion based on the power which is charged in the high voltage battery B1 so as to charge the battery B2 or supply power to the load L.

If the high voltage battery B1 is continuously used, a voltage of the high voltage battery B1 gradually drops. If the voltage of the high voltage battery B1 is lowered more than a predetermined voltage (first voltage reference value), power which is charged in the high voltage battery B1 is consumed, and the power is not effectively charged in the battery B2. Accordingly, in S114, the power supply device 10 checks whether or not an output voltage of the high voltage battery B1, in other words, an input voltage which is detected by the input voltage detection unit 5 is lowered more than the predetermined voltage (for example, 200 V). If the input voltage is equal to or higher than the predetermined voltage, the power supply device 10 performs power conversion, but in a case where the input voltage is lower than the predetermined voltage, the power supply device 10 makes the control unit 4 stop the voltage conversion and thereby charging of the battery B2 and supplying of power to the load L are stopped, in S116.

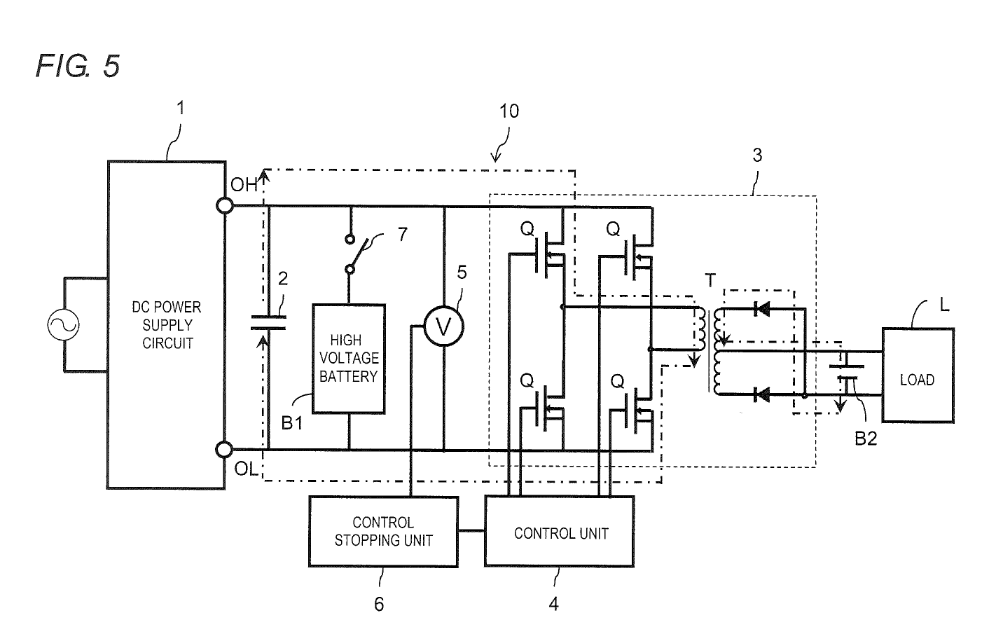

In S102, in a case where the high voltage battery B1 is in a state of being disconnected, the power supply device 10 performs a voltage conversion to discharge the electric charges which are charged in the smoothing capacitor 2 in S104. As illustrated in FIG. 5, even in a case where the high voltage battery B1 is disconnected from the present device by the switch 7, the electric charges which are charged in the smoothing capacitor 2 and remain are discharged as voltage conversion control is performed by the control unit 4, and the electric charges are charged in the battery B2. If the high voltage battery B1 is removed after the charging is terminated, an operator can receive an electric shock due to the electric charges remaining in the smoothing capacitor 2, but by doing so, it is possible to quickly discharge the electric charges remaining in the smoothing capacitor 2, and to prevent the operator from receiving an electric shock.

In S106, the power supply device 10 confirms whether or not the electric charges which are charged in the smoothing capacitor 2 are sufficiently discharged. In order to confirm whether or not the electric charges which are charged in the smoothing capacitor 2 are sufficiently discharged, for example, whether or not the smoothing capacitor 2 is discharged for a predetermined time, whether or not a predetermined amount of electric charges from the smoothing capacitor 2 are discharged, or the like is confirmed.

In addition, in order to confirm whether or not the electric charges which are charged in the smoothing capacitor 2 are sufficiently discharged, it may be checked whether or not a voltage (input voltage which is detected by the input voltage detection unit 5) which is generated by the remaining electric charges of the smoothing capacitor 2 is less than the second voltage reference value which is a predetermined voltage less than the first voltage reference value that stops the voltage conversion control in S114. The second voltage reference value is a low voltage of, for example, approximately 20 V, and a value which does not give an electric shock. In addition, the amount of electric charges or time which is taken until the electric charges remaining in the smoothing capacitor 2 are reduced, for example, from 300 V to 20 V can be easily calculated by an experiment or the like which is performed in advance. In this way, by performing the voltage conversion control until a voltage which is input to the voltage conversion circuit 3 is less than a predetermined voltage reference value (second voltage reference value), the electric charges remaining in the smoothing capacitor 2 can become very stable electric charges.

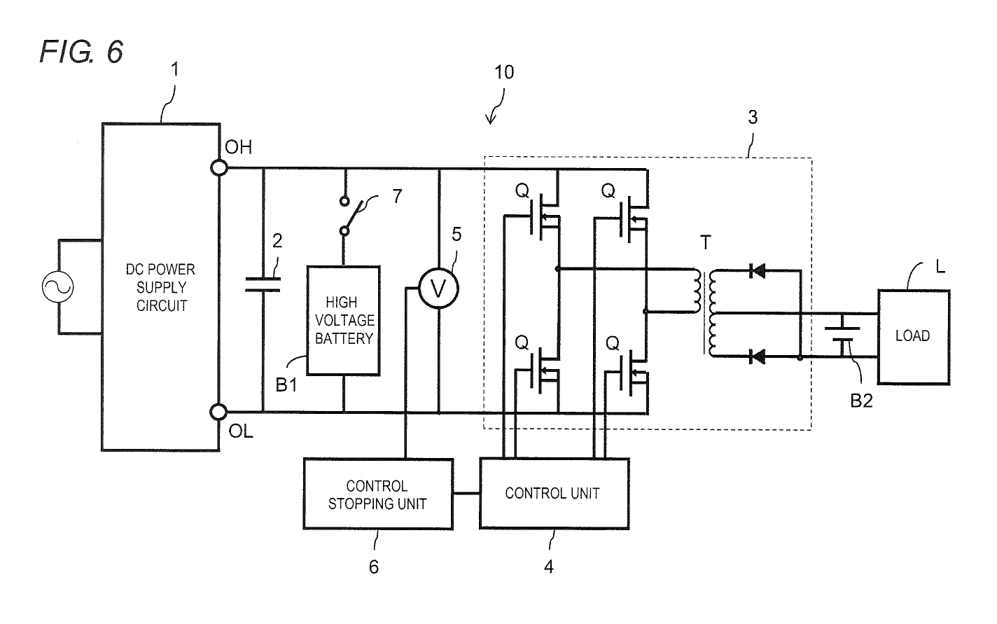

In addition, in a case where it is determined that the electric charges are sufficiently discharged from the smoothing capacitor 2, the power supply device 10 stops discharging by stopping the voltage conversion in S108. FIG. 6 illustrates a time when discharging is terminated, and illustrates a state where the high voltage battery B1 is disconnected from the present device, and the majority of electric charges does not remain in the smoothing capacitor 2.

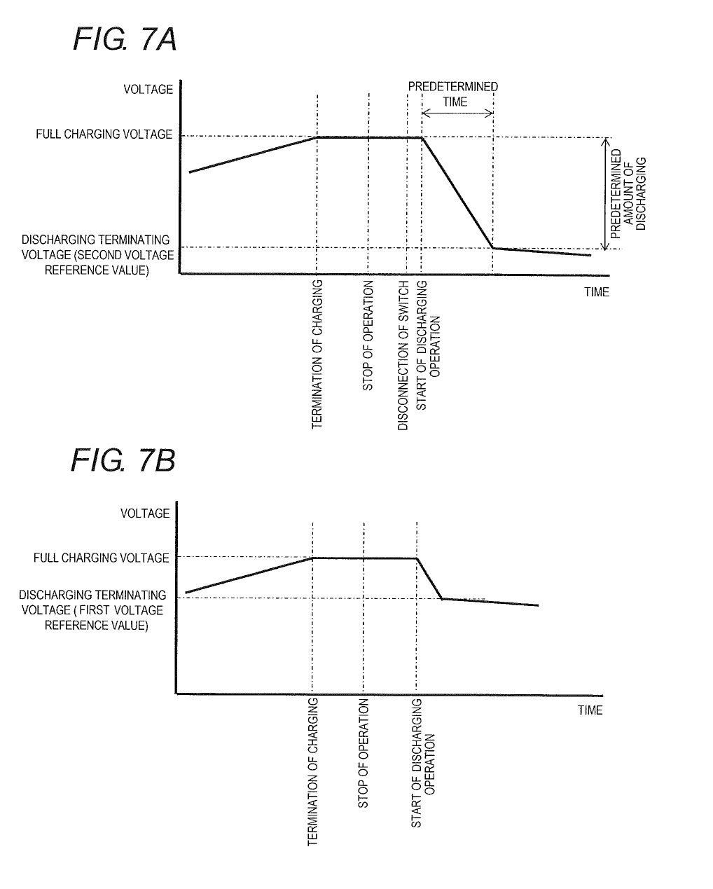

FIGS. 7A and 7B are characteristic diagrams illustrating voltage characteristics at the time of disconnecting or connecting a switch 7. The power supply device 10 performs charging until a full charging voltage is made, and terminates charging at the time of being fully charged. In addition, in FIG. 7B, in a state where the switch 7 is switched on after a vehicle or the like which uses the power supply device 10 completely stops an operation, a voltage conversion operation is performed to supply power to the load L and to charge the battery B2. The voltage conversion operation is terminated when the converted voltage reaches a voltage (first voltage reference value) by which the battery B2 cannot be effectively charged, that is, an input voltage to the voltage conversion circuit 3 is less than the first voltage reference value.

Meanwhile, as illustrated in FIG. 7A, in a case where the switch 7 is in an OFF state after a vehicle or the like which uses the power supply device 10 completely stops an operation, a voltage conversion operation is performed to sufficiently discharge the electric charges which are charged in the smoothing capacitor 2. In the voltage conversion operation, discharging is performed until the converted voltage becomes a voltage (second voltage reference value) which is less than the first voltage reference value and by which an operator does not receive an electric shock, and is terminated when the input voltage to the voltage conversion circuit 3 is less than the second voltage reference value.

As described above, the high voltage battery B1 enters a state of being disconnected from a state of being connected after an operation is stopped, and the power supply device 10 performs a voltage conversion operation for different objective. Although an input voltage which is detected by the input voltage detection unit 5 is less than the first voltage reference value by which the voltage conversion control that is performed by the control unit 4 is stopped in a state where the switch 7 is switched on, the power supply device 10 stops the voltage conversion control which is performed by the control unit 4, in a case where the switch 7 is switched off, after the voltage conversion control which is performed by the control unit 4 is continued for a predetermined time such that the electric charges which are charged in the smoothing capacitor 2 are discharged by a predetermined amount. According to this, in a case where the high voltage battery B1 is removed after a charging operation is terminated or travel of a vehicle is terminated, it is possible to provide the power supply device 10 which can quickly discharge the electric charges remaining in the smoothing capacitor 2.

In addition, the aforementioned contents can be understood by a method for controlling a power supply device which includes a DC power supply circuit which supplies DC power to one battery, a smoothing capacitor which is connected to an output side of the DC power supply circuit, and a voltage conversion circuit which supplies DC power to another battery by converting a voltage that is output from the DC power supply circuit into another voltage. That is, the method is a control method in which, although a voltage that is input to the voltage conversion circuit is less than a reference value by which a voltage conversion control is stopped, in a case where one battery is in a state of being disconnected, the voltage conversion circuit stops after a voltage conversion is continued for a predetermined time such that electric charges which are charged in a smoothing capacitor are discharged by a predetermined amount. According to this, it is possible to provide a method for controlling a power supply device in which, although the voltage that is input to the voltage conversion circuit is less than the reference value by which the voltage conversion control is stopped, in a case where the battery is in a state of being disconnected, the voltage conversion is performed for a predetermined time such that the electric charges which are charged in the smoothing capacitor are discharged by a predetermined amount, and thus, in a case where the battery is removed after the charging operation is terminated or the travel of a vehicle is terminated, the electric charges remaining in the smoothing capacitor can be quickly discharged.

The invention is not limited to the exemplified examples, and can be realized by a configuration in a range without departing from the content described in each section of the scope of Claims. That is, the invention illustrates and describes mainly and particularly with regard to a specific embodiment, but those skilled in the art can variously modify the aforementioned embodiments, with regard to quantity and other detailed configurations, without departing from the technical idea and a range of the objective of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A power supply device which charges a battery and converts a DC voltage into another DC voltage, said power supply device comprising:
a DC power supply circuit which supplies DC power to a first battery;
a smoothing capacitor which is connected to an output side of the DC power supply circuit;
a voltage conversion circuit which converts a voltage output from the DC power supply circuit into another voltage, and which supplies DC power to a second battery;
a control unit which controls a voltage conversion of the voltage conversion circuit;
an input voltage detection unit which detects an input voltage of the voltage conversion circuit;
a switch which electrically connects or disconnects the first battery to the power supply device; and
a control stopping unit which stops voltage conversion control performed by the control unit, in a case where the input voltage detected by the input voltage detection unit is less than a first voltage reference value,
wherein in a case where the switch is switched off, after the voltage conversion control performed by the control unit is continued for a predetermined time such that electric charges charged in the smoothing capacitor are discharged by a predetermined amount, the control stopping unit stops the voltage conversion control performed by the control unit.

2. The power supply device according to claim 1, wherein when an input voltage detected by the input voltage detection unit is less than a second voltage reference value that is smaller than the first voltage reference value, the control stopping unit stops the voltage conversion control performed by the control unit.

3. A method for controlling a power supply device which comprises a DC power supply circuit which supplies DC power to a first battery, a smoothing capacitor which is connected to an output side of the DC power supply circuit, a voltage conversion circuit which converts a voltage output from the DC power supply circuit into another voltage and which supplies DC power to another battery, said method comprising:
stopping voltage conversion control, in a case where a voltage input to the voltage conversion circuit is less than a predetermined reference value; and
causing the voltage conversion circuit to stop after a voltage conversion is continued for a predetermined time such that electric charges charged in the smoothing capacitor are discharged by a predetermined amount, in a case where the first battery is in a state of being disconnected.
